(19) United States
(12) Patent Application Publication
(10) Pub. No.: US 2021/0081893 A1
(43) Pub. Date: Mar. 18, 2021

(54) INTERACTIVE REPRESENTATION OF A ROUTE FOR PRODUCT TRANSPORTATION

(71) Applicant: Oracle International Corporation, Redwood Shores, CA (US)

(72) Inventors: Jennifer Darmour, Seattle, WA (US); Loretta Marie Grande, Seattle, WA (US); Ronald Paul Lapurga Viernes, Seattle, WA (US); Jingyi Han, San Jose, CA (US); Nicole Santina Giovanetti, Rancho Cordova, CA (US); Jason Wong, Seattle, WA (US); Min Hye Kim, Newcastle, WA (US)

(73) Assignee: Oracle International Corporation, Redwood Shores, CA (US)

(21) Appl. No.: 17/078,847

(22) Filed: Oct. 23, 2020

Related U.S. Application Data
(63) Continuation-in-part of application No. 17/020,612, filed on Sep. 14, 2020, now abandoned.
(60) Provisional application No. 62/900,494, filed on Sep. 14, 2019.

(51) Int. Cl. G06Q 10/08; G01C 21/36; G01C 21/34; G06N 20/00; G06K 9/62

(52) U.S. Cl. CPC G06Q 10/0833; G01C 21/3605; G06K 9/6256; G01C 21/367; G06N 20/00; G01C 21/3461

(57) ABSTRACT

Techniques for applying a machine learning model to historical shipping data to generate an interactive graphical user interface of a transport route are disclosed. A machine learning model is trained to compute route attributes for at least one transport provider for transporting items along a route between a source location and a destination location. The system is further configured to display the actual or estimated location of an item along the route based on a timeline. The position of the item along the route is updated as the user drags a time marker along a timeline. The system identifies and displays the attributes of the transportation segment that includes the currently displayed position of the item along the route.

### BENEFIT CLAIMS; RELATED APPLICATIONS; INCORPORATION BY REFERENCE

This application claims the benefit as a Continuation-In-Part of U.S. Non-Provisional patent application Ser. No. 17/020,612, filed Sep. 14, 2020 which claims the benefit of U.S. Provisional Application 62/900,494, filed Sep. 14, 2019, both of which are hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to graphical user interfaces (GUI). In particular, the present disclosure relates to applying a machine learning model to display an interactive representation of a route for product transportation.

### BACKGROUND

A transportation management system may be configured to track product transportation. Transporting a product from a source location to a destination location may involve various intermediary locations along a delivery route, each intermediary location being associated with one or more tasks. For each segment of the delivery route, there may be different transport provider companies, transport provider workers, transport tasks, completion times, deadlines, and costs.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for applying a machine learning model to display an interactive representation of a route for product transportation in accordance with one or more embodiments;

FIG. 3 illustrates an example of a set of operations for training a machine learning model to estimate route characteristics in accordance with one or more embodiments;

FIGS. 4A-4D illustrate example graphical user interfaces for displaying an interactive representation of a route for product transportation; and

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. INTERACTIVE ROUTE SYSTEM ARCHITECTURE
3. DISPLAYING AN INTERACTIVE REPRESENTATION OF A ROUTE FOR PRODUCT TRANSPORTATION
4. MACHINE LEARNING ENGINE TRAINING FOR ROUTE CHARACTERISTICS
5. EXAMPLE EMBODIMENT
6. COMPUTER NETWORKS AND CLOUD NETWORKS
7. MISCELLANEOUS; EXTENSIONS
8. HARDWARE OVERVIEW

### 1. General Overview

One or more embodiments implement a machine learning model that computes the attributes of a transportation plan for transporting an item along a route. The system trains the machine learning model with historical route information for previously transported items including transportation providers, transportation times, transportation costs, and transportation routes. When a user selects a particular route for display, the system applies the machine learning model to compute and display estimated transportation providers, routes, times, and costs.

One or more embodiments implement an interface that displays an interactive representation of a route for product transportation. The system may display a position of a product along a route. As the user drags a time marker along a timeline, the position of the product is updated. The position may correspond to an estimated position or actual position data based on a given point-in-time. The point-in-time may be an actual time such as Mar. 2, 2020 at 2 pm (which may have already occurred, or which may be in the future). The point-in-time may be a period of time relative to the start time such as (3) days after the packet has left the source location.

The system may further identify and display attributes corresponding to the displayed position of the product along the route. The system may display information about the transportation segment that includes the displayed position of the product along the route. The information about the transportation segment may identify, for example, the transport provider, the cost, the time, and the type of transport. In an example, the system may display the product along a transportation segment within a building. In an example, a location along the route, such as a reception desk, may be visually tagged with the specific individual who will be receiving the item, or who has received the item. The system may display detailed location information such as a 3D visualization of a particular shelf within a building that has been identified as a destination for the item.

The attributes corresponding to the displayed position may (a) be estimated by the machine learning model based on historical data, (b) determined based on logged data corresponding to completed transportation segments, and/or (c) determined based on a particular order that specifies the attributes of the transportation plan for an item.

One or more embodiments described in this Specification and/or recited in the claims may not be included in this General Overview section.

### 2. Interactive Route System Architecture

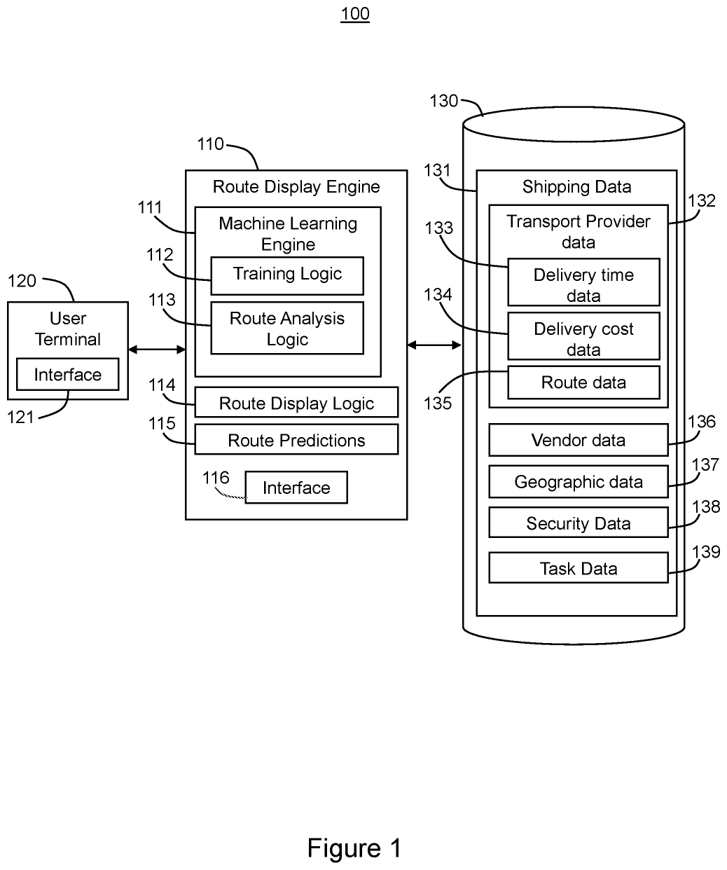

FIG. 1 illustrates a system 100 in accordance with one or more embodiments. The system 100 includes a route display engine 110, user terminal 120, and repository 130.

The route display engine 110 includes a machine learning engine 111 including training logic 112 and route analysis logic 113. The training logic 112 obtains shipping data 131 from the data repository 130 and trains a machine learning model, using the shipping data 131, to generate route predictions 115 based on the shipping data 131. The shipping data 131 may include transport provider data 132, including delivery time data 133, delivery cost data 134, and route data 135, such as streets and geographic features along the route. The shipping data 131 also includes vendor data 136, such as vendor costs and a time for a vendor to ship an item. The shipping data 131 also includes geographic data 137. Geographic data 137 includes street maps, aerial maps or photographs, and building maps or diagrams. The shipping data 131 also includes security data 138. Security data 138 includes identification of individuals along a route who will be responsible for handling an item, secure locations where an item may be stored, and secure codes or information for obtaining an item from a secure location. The shipping data 131 also include task data 139. A task is a piece of work to be done or undertaken in the course of transporting an item or product from a source location to a destination location. In one or more embodiments, a task may involve moving an item from a starting location of a segment of the representation of the route to an end location of the segment. Additionally or alternatively, a task may be performed at a single location along a route from a source location to a destination location. Examples of tasks include, for example, delivering the item from one location to another location, providing a receipt signature at a particular location, verifying a condition and/or quality of the item received at a particular location, and packaging and/or storing the item in a particular manner at a particular location.

As an example, transporting an item from a source location to a destination location may involve three tasks. A first task may be moving the item from the source location (referred to as a “starting location of a first segment of the route”) to another location (also referred to as an “end location of the first segment”). A second task may be confirming receipt of the item at the end location of the first segment. A third segment may be moving the item from the end location of the first segment (also referred to as a “starting location of a second segment of the route”) to the destination location.

A task is associated with one or more attributes. Examples of task attributes include one or more transport providers responsible for carrying out the task, an estimated duration used for performing the task, a deadline for performing first task, a cost for performing the task, a current status of the task (such as completed, in progress, not yet started). A transport provider may be a company, organization, department, person, and/or other entity.

While examples of shipping data 131 are provided, embodiments are not limited to the above-described examples. Shipping data 131 includes any data that is used by the machine learning engine 111 to train a machine learning model to estimate route information, and any data used by the route display logic 114 to display a route between a source location and a destination location.

The route analysis logic 113 analyzes routes, based on user input from an interface 121 of the user terminal 120, to identify one or more routes to be displayed by the route display engine 110. Route display logic 114 generates display information, such as graphical user interface (GUI) data that is transmitted to the user terminal 120 via the interface 116 to display one or more routes on the user terminal 120. The GUI includes a representation of a route to be used by a transport provider to transport an item. In one or more embodiments, the representation of the route is interactive. A user may interact with the representation to select a position along a displayed route to obtain task information associated with the selected position.

Additional embodiments and/or examples relating to computer networks are described below in Section 6, titled “Computer Networks and Cloud Networks.”

In one or more embodiments, a data repository 130 is any type of storage unit and/or device (e.g., a file system, database, collection of tables, or any other storage mechanism) for storing data. Further, a data repository 130 may include multiple different storage units and/or devices. The multiple different storage units and/or devices may or may not be of the same type or located at the same physical site. Further, a data repository 130 may be implemented or may execute on the same computing system as the route display engine 110. Alternatively or additionally, a data repository 130 may be implemented or executed on a computing system separate from the route display engine 110. A data repository 130 may be communicatively coupled to the route display engine 110 via a direct connection or via a network.

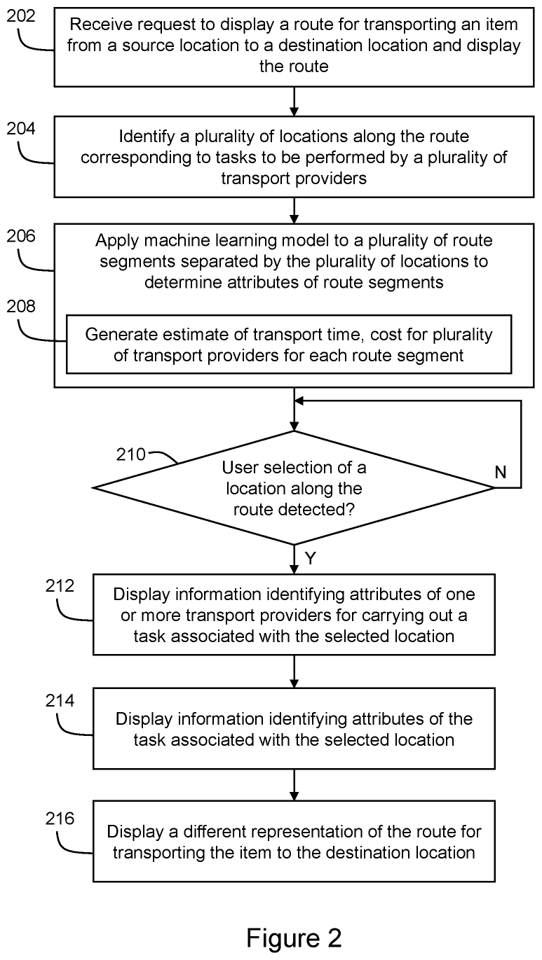

In one or more embodiments, the route display engine 110 refers to hardware and/or software configured to perform operations described herein for analyzing and presenting data. Examples of operations for applying a machine learning model to compute and display interactive route attributes for transporting an item along a route are described below with reference to FIG. 2.

In an embodiment, the route display engine 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, interface 121 of the user terminal 120 refers to hardware and/or software configured to facilitate communications between a user and the route display engine 110. The interface 121 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 121 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 121 is specified in one or more other languages, such as Java, C, or C++.

### 3. Displaying an Interactive Representation of a Route for Product Transportation

FIG. 2 illustrates an example set of operations for applying a machine learning model to display an interactive representation of a route for product transportation in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

A system receives a request to display a route for transporting an item from a source location to a destination location (Operation 202). In one embodiment, a user interacts with a graphical user interface (GUI) to display the route for transporting the item on a graphic representing a map. A route display engine causes a GUI to display a representation of the route for transporting an item to a destination location. As an example, a GUI may display a line that represents a route for transporting an item to a destination location. The line may be displayed over a background that is relevant to the route. The background may be for example a map, a floor plan, a building plan.

The system identifies locations along the route that correspond to tasks to be performed by transport providers. (Operation 204). As discussed above, tasks are pieces of work to be done or undertaken in the course of transporting an item along the route. For example, a task may be that the item may is transferred from one transport provider to another, the item is combined with another item, or the item is be delivered to a storage location. A route may include any number of identified tasks.

In one or more embodiments, a user selects which tasks to be displayed along the route. For example, in one embodiment, a user is provided with a menu giving the user to display any of the above-described tasks, and the user selects to display only the transfer of the item from one transport provider to another.

The system applies a machine learning model to the route segments, defined as the division in the route that are separated by the tasks, to determine attributes of the route segments (Operation 206). The machine learning model is trained using historical data about transport routes, transport providers, and vendors. The machine learning model analyzes a training data set to identify data and patterns and generates cost and time estimates for the route based on the identified data and patterns. Types of machine learning models include but are not limited to linear regression, logistic regression, linear discriminant analysis, classification and regression trees, naïve Bayes, k-nearest neighbors, learning vector quantization, support vector machine, bagging and random forest, boosting, backpropagation, and/or clustering.

The system uses the machine learning model to generate an estimate of the transport time, cost, and route taken for each route segment (Operation 208). For example, if the route includes one task in which the item is delivered from one transport provider to another, the system determines that the route has two segments (one segment for each transport provider). The system generates estimates of the transport time, cost, and route taken in each of the two segments.

The system waits for a user to select a location along the route (Operation 210). The user selection is provided by a selection icon, such as a mouse cursor, on the GUI, by typed instructions, or by any other method for selecting a location along a route.

If a user selection of a location along the route has not been received, the GUI may further display one icon representing the source location, and another icon representing the destination location. The line representing the route may connect the two icons representing the source location and the destination location, respectively. Alternatively, if a user selection of a location along the route has been received (for example, at Operation 210), the GUI may further display one icon representing the selected location, and another icon representing the destination location. The line representing the route may connect the two icons representing the selected location and the destination location, respectively.

In an embodiment, the route display engine selects one of a pool of background types for a background to be displayed with a route representation. Additionally, or alternatively, the route display engine selects one of a pool of representation types for displaying the route representation. Additionally, or alternatively, the route display engine selects one of a pool of icon types for displaying icons representing the source location, the selected location, and/or the destination location. The route display engine causes the GUI to use the selected background type, representation type, and/or icon type to display a route representation.

Examples of background types include an outdoor map and an indoor map. An outdoor map includes one or more outdoor features, such as a road, a river, a city boundary, a state boundary, a park. An indoor map includes one or more indoor features, such as a wall, a room, a floor, an elevator, an escalator, a set of stairs, a door. An indoor map may be, for example, a floor plan or a building plan. Examples of background types further include a three-dimensional (3D) map and a two-dimensional (2D) map. As an example, a route display engine may obtain a floor plan of a building. The floor plan indicates locations of walls and doors inside the building. A GUI may render a 3D image representing the interior of the building by rendering 3D walls based on the locations of walls as indicated by the floor plan. In this example, a background type used is a 3D indoor map.

Examples of representation types include a single straight line, a collection of straight lines, and a line that follows a realistic path of the route in the real world. A line that follows a realistic path of the route may consider one or more physical barriers along the route. As an example, a line that follows a realistic path of a route may follow the path of a road from one location to another location. As another location, a line that follows a realistic path of a route may curve around hallways to connect one location to another location.

Examples of icon types include 3D icons and 2D icons. For example, a 3D icon may be a 3D image of a building, or a 3D image of a storage room. A 2D icon may be a 2D shape (such as a rectangular shape or circular shape).

In an embodiment, if a user selection of a location along the route has not been received, the selection of background types, representation types, and/or icon types is based on a relationship between the source location and the destination location. Alternatively, if a user selection of a location along the route has been received (for example, at Operation 210), the selection of background types, representation types, and/or icon types is based on a relationship between the selected location and the destination location. The relationship between the source location and the destination location, and/or the relationship between the selected location and the destination location, may be referred to herein as a “location relationship.”

The route display engine may determine the location relationship based on (a) a straight line distance between the selected location and the destination location, (b) a traveling distance between the selected location and the destination location, (c) a vertical elevation between the selected location and the destination location, (d) whether the selected location is a street address or a room number or another expression, (e) whether the destination location is a street address or a room number or another expression, and/or other factors. Different background types, representation types, and/or icon types may correspond to different location relationships, in accordance with a lookup table, a set of rules, a function, a set of mappings, and/or other data structures and/or executable instructions.

As an example, a route display engine may determine that a relationship between a selected location and a destination location indicates a traveling distance that is greater than a threshold value. The route display engine may hence select a 2D outdoor map as a background type for displaying a route representation.

As another example, a route display engine may determine that a relationship between a selected location and a destination location indicates a vertical elevation that involves multiple floors of a building. The route display engine may hence select a 3D indoor map, which includes 2D representations of each floor, as a background type for displaying a route representation.

As another example, a route display engine may determine that a relationship between a selected location and a destination location indicates (a) a vertical elevation that involves a single floor of a building and (b) a route between the selected location and the destination location is encompassed indoors. The route display engine may hence select a 3D indoor map, which includes 3D representations of walls, as a background type for displaying a route representation.

One or more embodiments include determining whether a user selection of a location along the route has been received (Operation 210). The route display engine determines whether a user selection of a location along the route has been received via the GUI. The route display engine may wait until a user selection is received.

Various user interface elements may be used for receiving the user selection.

As an example, a GUI may display a position marker along a representation of a route. A user may drag the position marker from one position along the route representation to another position along the route. The location represented by the position at which the position marker is dropped may thereby be selected.

As another example, a GUI may display buttons along a representation of a route. A user may click on one of the buttons displayed at a particular position along the route representation. The location represented by the particular position may thereby be selected.

In an embodiment, the route display engine optionally displays a representation of a sequence of tasks that are performed along the route. The route display engine optionally displays selectable icons along the representation of the sequence of tasks, each selectable icon representing one of the tasks. A user may select a task using a selectable icon. The route display engine may determine a location associated with the selected task. The location associated with the selected task may therefore be considered “selected” by the user.

Upon detecting the user selection, the system displays for the user attributes of a transport provider that will carry out the task associated with the selected location (Operation 212). Attributes of a transport provider include, for example, a name of a worker performing a task, a photo of a worker performing a task, a position or role of a worker performing a task, a name of a company responsible for performing a task. For example, if the selection is in a first segment of a route having two segments, the system displays the information about the transport provider assigned to transport the item in the first segment. The displayed information includes the predicted or estimated transport time, cost, and route to be taken by the transport provider. The displayed information is generated based on the application of the machine learning model to the historical data associated with the transport provider. In one or more embodiments, the displayed information includes attributes of a plurality of transport providers, and the GUI allows a user to select a particular transport provider to transport the item along the segment corresponding to the selected location. The system may simultaneously display transport cost and time information for more than one transport provider and allow the user to select between the transport providers.

One or more embodiments include, based on the user selection of the location along the route, selecting a different representation of the route for transporting the item to the destination location (Operation 216). The different representation of the route may include a different background type, representation type, and/or icon type. For example, the route display engine may initially display an outdoor 2D representation of the transport route. If the user selects a location along the route that is determined to correspond to a building, the route display engine changes the background type to a 3D representation of the building.

The route display engine then iterates Operation 202 to display the route representation, but now using the newly selected background type, representation type, and/or icon type. The route display engine then iterates Operations 210-216. The route display engine continues to update the GUI to display the route representation and task information associated with a currently-selected location along the route.

### 4. Machine Learning Engine Training for Route Attributes

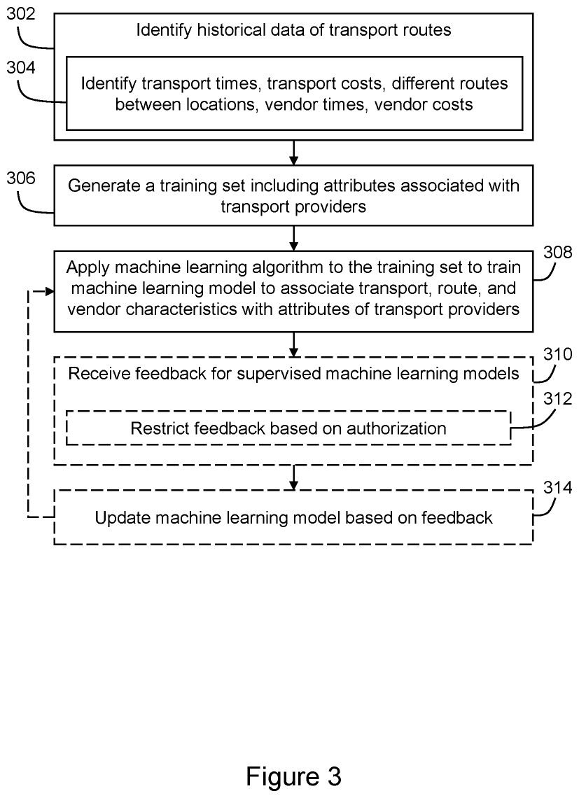

FIG. 3 illustrates an example set of operations for training a machine learning model to estimate route attributes for a transport provider in accordance with one or more embodiments. The method includes identifying or obtaining historical data of transport routes (Operation 302). Obtaining the historical data may include obtaining, for one or more transport providers, transport times, transport costs, and routes traveled (Operation 304). The historical data may also include vendor information such as a time to fulfill an order and ship an item, vendor costs, and vendor location.

Once the various data (or subsets thereof) are identified in the Operation 304, the identified and/or selected data may be used to generate a training set of data (Operation 306). Training data may include attributes associated with one or more transport providers as well as patterns in transport provider and vendor services.

Once the various training materials have been identified, machine learning algorithm may be applied to the training data set (Operation 308). The machine learning algorithm analyzes the training data set to estimate routes, costs, and transport times associated with an item to be transported. Identifying routes may include identifying particular tasks along a route. Different routes may have different associated tasks. The machine learning algorithm may calculate how the different routes and tasks affect costs and transport times. Types of machine learning models include but are not limited to linear regression, logistic regression, linear discriminant analysis, classification and regression trees, naïve Bayes, k-nearest neighbors, learning vector quantization, support vector machine, bagging and random forest, boosting, backpropagation, and/or clustering.

In embodiments in which the machine learning algorithm is a supervised machine learning algorithm, the system may optionally obtain feedback on the various aspects of the analysis described above (Operation 310). For example, the feedback may affirm or revise values associated with transport time or cost, with preferred transport routes, or with tasks that are present along particular routes, among other aspects.

In some examples, the feedback may be restricted to those authorized to provide the feedback, such as a manager or person authorized to direct shipping, and the like (operation 312).

Based on association identified by the machine learning model and/or feedback, the machine learning training set may be updated, thereby improving its analytical accuracy (operation 314). One benefit of using a trained machine learning model in this context is that it improves the accuracy estimates or predictions regarding the cost and time of transport of items. Users can visualize different costs and travel times of items using different routes and different transport providers based on past data associated with the transport providers. While transport providers may often provide generalized guidance regarding transport times, such as a standard window of time in which an item may be delivered, utilizing a machine learning model allows operators to obtain a more accurate estimate of transport costs and times based on past performance.

Once updated, the machine learning model may be further trained by optionally applying it to additional training materials.

### 5. Example Embodiments

Detailed examples are described below for purposes of clarity. Components and/or operations described below should be understood as specific examples which may not be applicable to certain embodiments. Accordingly, components and/or operations described below should not be construed as limiting the scope of any of the claims.

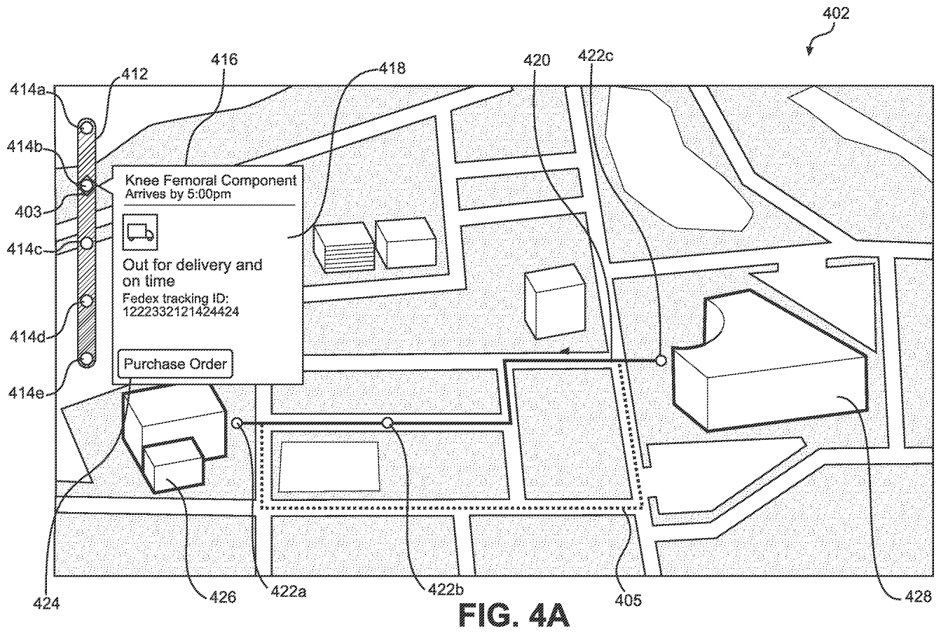

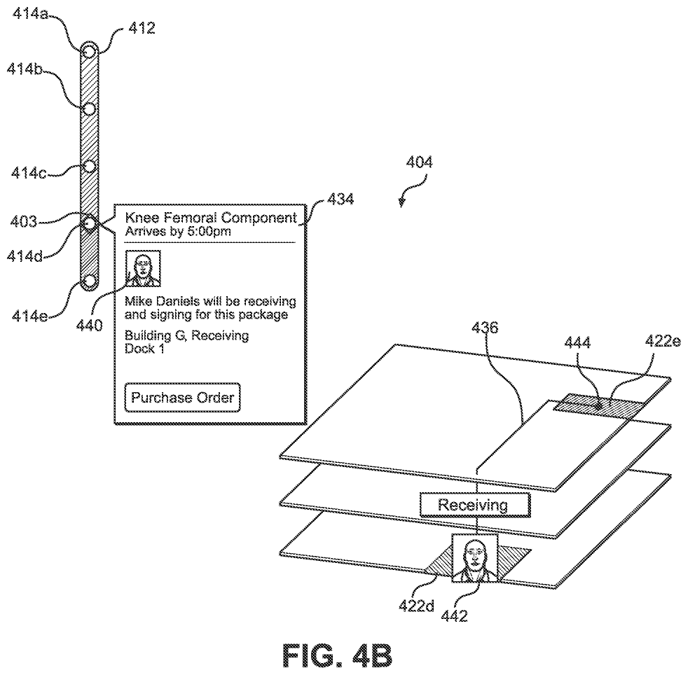

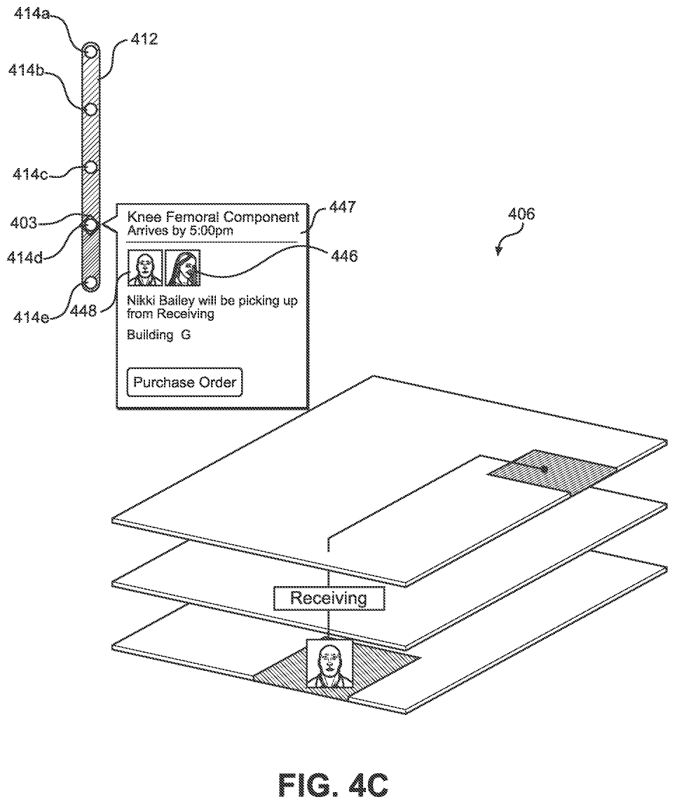

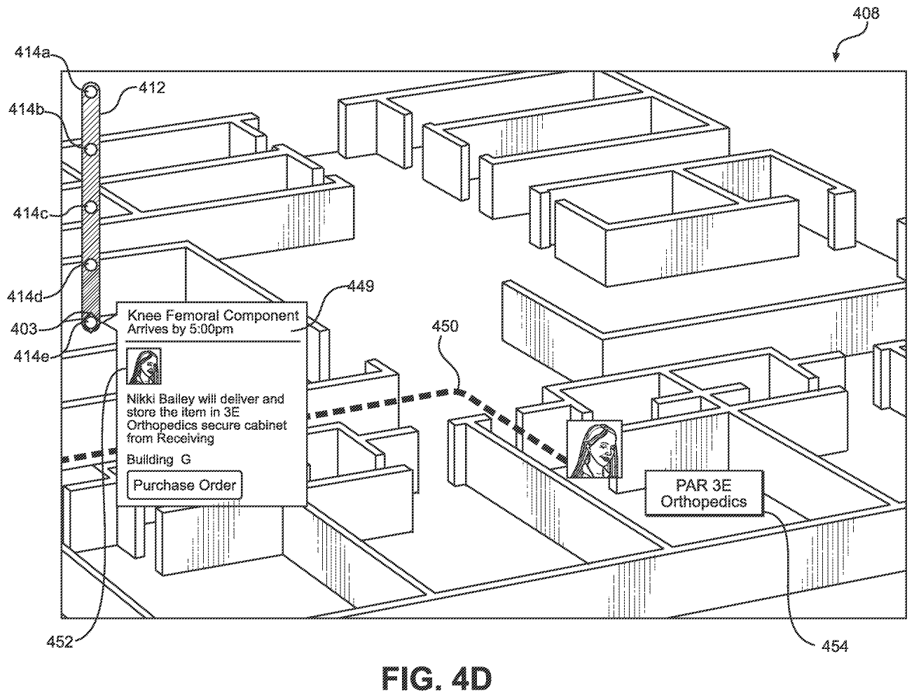

FIGS. 4A-D illustrate example graphical user interfaces for displaying an interactive representation of a route for product transportation, in accordance with one or more embodiments.

Initially, a route display engine receives a request for displaying an interactive representation of a route for transporting item 416, which is a knee femoral component, from source location 426, which is Lee's Supplies, to destination location 428, which is a particular location within Supremo Healthcare.

Referring to FIG. 4A, the route display engine applies a machine learning model to parameters of the request to generate estimated route data, including transport time, transport costs, and tasks along the route. The route display engine causes GUI 402 to display route representation 412 and route representation 420. The route representation 412 is a graphical representation of the route divided into segments by different tasks along the route. The route representation 412 may represent a timeline of the transport of the item 416 along the route. The route representation 420 is a graphical representation of a geographical path a transport provider takes between the source location 426 and the destination location 428. Selectable positions 414a-414e are displayed along route representation 412. Selectable positions 422a-422c are displayed along route representation 420. In one embodiment, selectable positions 414a-414e correspond to different tasks along the route representation 412. In FIG. 4A, for example, the selectable position 414a along the route representation 412 corresponds to the selectable position 422a along the route representation 420. In addition, the selectable positions 414b and 414c correspond to the selectable positions 422b and 422c, respectively. Additional selectable positions may also be available.

Since the route display engine has not yet received any user selection of a location along the route, the route display engine determines a background type, representation type, and icon type for route representation 420 based on a location relationship between source location 426 and destination location 428. In the example of FIG. 4A, since the location relationship is two addresses separated by streets, the route display engine determines a “street map” background type, for example.

The route representation 412 includes a time marker 403 that is movable or slidable along the route representation 412. Moving or sliding the time marker 403 causes the route display engine to change a corresponding GUI and task attributes. For example, moving or sliding the time marker 403 from selectable position 414a to selectable position 414b changes task information from information associated with the source location 426 to task information associated with the transport route representation 420. Moving or sliding the time marker 403 from selectable position 414b to 414d causes the route display engine to modify the GUI as described below in connection with FIG. 4B.

The route display engine may cause GUI 402 to display task attributes 418 of a task associated with source location 426. Task attributes 418 include an estimated completion time, “Arrives by 5:00 pm”; a status, “Out for delivery and on time”; and a tracking identifier. Additionally, button 424 is selectable to request information associated with a purchase order for item 416.

The route display engine may cause the GUI to display an alternative route 405. The alternative route 405 may be selectable by a user to display route attributes, including estimated transport times and costs, and alternative transport providers.

Referring to FIG. 4B, the route display engine receives a user selection of location 422d, which is a Receiving Room within Supremo Healthcare. Alternatively, the user may move the time marker 403 to the selectable position 414d. The route display engine determines that a task associated with location 422d is “receiving and signing” for item 416. The route display engine causes GUI 404 to display attributes of transport provider 440 responsible for carrying out the task. A name, Mike Daniels, and a photo of transport provider 440 are shown. The route display engine causes GUI 404 to display task attributes 434. Task attributes 434 include a task description, “Mike Daniels will be receiving and signing for this package”; a specific location for the task, “Building G, Receiving Dock 1.”

The route display engine determines a location relationship between selected location 422d and destination location 422e. The location relationship indicates that selected location 422d and destination location 422e are on different floors of the same building. Based on the location relationship, the route display engine selects a 3D indoor map, with 4D representations of each floor, as a background type. The route display engine selects a collection of straight lines as a representation type. The route display engine selects 4D images as icon types for selected location 422d and destination location 422e. Using the selected background type, representation type, and icon type, the route display engine causes GUI 404 to display route representation 436, an icon representing selected location 422d, and an icon representing destination location 422e. Additionally, the route display engine causes GUI 404 to display route representation 430.

Referring to FIGS. 4B and 4C, the route display engine receives another user selection of location 422d, which is a Receiving Room within Supremo Healthcare. The route display engine determines that another task associated with location 422d is “picking up” item 416. The route display engine causes GUI 406 to display attributes of transport providers 446-448 responsible for carrying out the task. Photos of transport providers 446-448 are shown. The route display engine causes GUI 406 to display task attributes 447. Task attributes 447 include a task description, “Nikki Bailey will be picking up the item from Receiving”; a specific location for the task, “Building G.”

Referring to FIG. 4D, the route display engine receives a user selection of destination location 454, which is the room 3E Orthopedics within Supremo Healthcare. Alternatively, the user may move the time marker 403 to the selectable position 414e. The route display engine determines that a task associated with destination location 454 is “delivering and storing” item 416. The route display engine causes GUI 408 to display attributes of transport provider 452 responsible for carrying out the task. A name, Nikki Bailey, and a photo of transport provider 452 are shown. The route display engine causes GUI 408 to display task attributes 449. Task attributes 449 include a task description, “Nikki Bailey will deliver and store the item in 3E Orthopedics secure cabinet”; a specific location for the task, “Building G.”

The route display engine determines that a location relationship between the selected location and destination location 454 is that the selected location is destination location 454. Based on the location relationship, the route display engine selects a 3D indoor map, with 3D walls, as a background type. The route display engine selects a line following a realistic path as a representation type. The line follows displayed 3D hallways to reach destination location 454. The route display engine selects a 3D image as an icon type for destination location 454. Using the selected background type, representation type, and icon type, the route display engine causes GUI 408 to display route representation 450, and a 3D room as an icon representing destination location 454. Additionally, the route display engine causes GUI 408 to display route representation 456.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

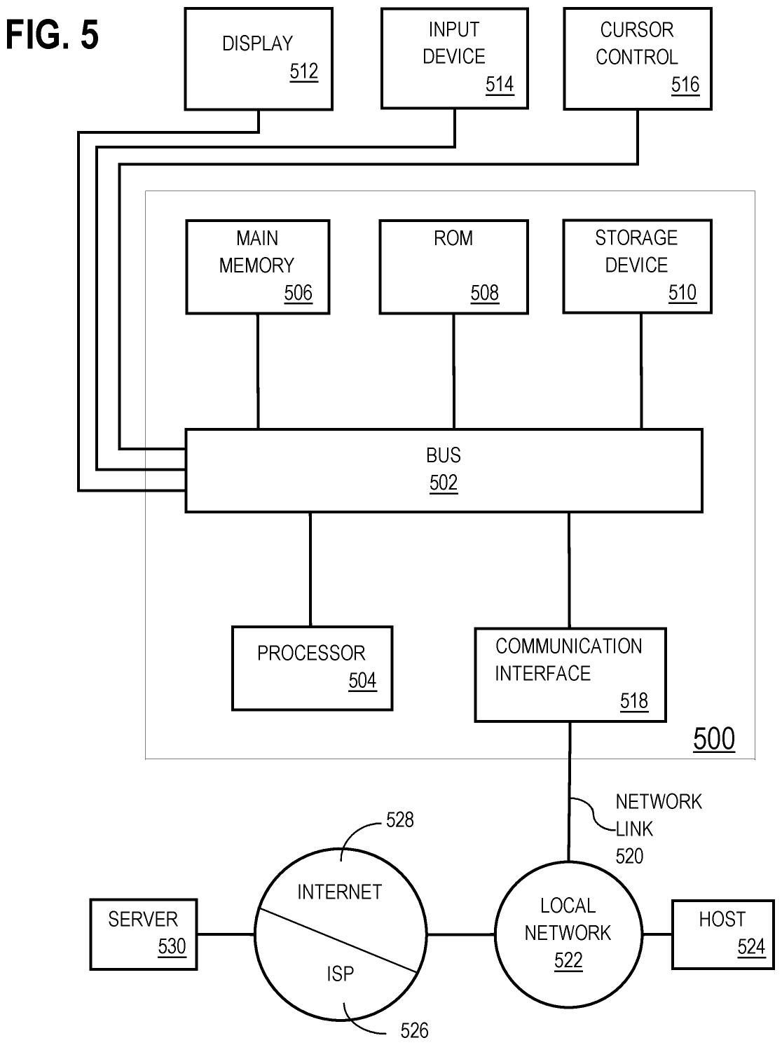

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory machine-readable media storing instructions which, when executed by one or more processors, cause:
training a machine learning model to compute route attributes for at least one transport provider for transporting items along a route between a source location and a destination location, the training comprising:
obtaining training data sets of historical transport data, each training data set comprising one or more of:
attributes of a particular transport provider for a prior transport of a particular item along a particular route;
a time taken by the particular provider for the prior transport of the particular item along the particular route; and
a cost for the prior transport of the particular item along the particular route; and
training the machine learning model based on the training data sets;
receiving a request to display the route for transporting a target item from the source location to the destination location;
applying the machine learning model to predict an estimated time and an estimated cost for transporting the target item from the source location to the destination location; and
displaying a representation of the route, the representation comprising the estimated time and the estimated cost predicted by the machine learning model.

2. The one or more media of claim 1, wherein:
responsive to receiving a first user selection of a first segment of the route: displaying information identifying a first transport provider, of a plurality of transport providers, that is responsible for transporting the target item along the first segment of the route;
responsive to receiving a second user selection of a second segment of the route: displaying information identifying a second transport provider, of the plurality of transport providers, that is responsible for transporting the target item along the second segment of the route; and
wherein the first transport provider and the second transport provider are different.

3. The one or more media of claim 1, wherein:
responsive to receiving a first user selection of a first location, of the plurality of locations, along the route: displaying information identifying a first transport provider, of the plurality of transport providers, that is responsible for carrying out a first task associated with the first location;
responsive to receiving a second user selection of a second location, of the plurality of locations, along the route: displaying information identifying a second transport provider, of the plurality of transport providers, that is responsible for carrying out a second task, of the plurality of tasks, associated with the second location;
wherein the first transport provider and the second transport provider are different.

4. The one or more media of claim 1, wherein:
responsive to receiving a first user selection of a first segment of the route: displaying one or more of: an estimated cost corresponding to the first segment of the route, or an estimated time corresponding to the first segment of the route.

5. The one or more media of claim 1, wherein the operations further comprise:
detecting user input that drags a time marker on a timeline;
responsive to and concurrently with detecting the user input:
moving a position marker along a representation of the route;
displaying information corresponding to a segment on the route currently associated with the position marker.

6. The one or more media of claim 1, wherein the operations further comprise: receiving user input selecting a position along the representation of the route corresponding to a change from a first transport provider to a second transport provider, and displaying information identifying the second transport provider.

7. The one or more media of claim 1, wherein:
responsive to receiving a selection of a second route for transporting the target item from the source location to the destination location:
displaying a second representation of the second route, the second representation comprising a second estimated time and a second estimated cost predicted by the machine learning model.

8. The one or more media of claim 1, further storing instructions which cause:
determining that the first location corresponds to a transfer point for transfer of the item between different transport providers;
displaying information associated with the transfer, the information associated with the transfer comprising one or more attributes of the first transport provider that is responsible for delivering the item at the transfer point.

9. The one or more media of claim 8, wherein the operations further comprise:
displaying a photograph of the item as received at the first transport point.

10. The one or more media of claim 1, wherein the data sets further comprise one or more of:
different routes traveled by the transport provider between the source location and the destination location;
time taken by a vendor associated with the source location to ship the item; and
costs attributed to the vendor to ship the item.

11. The one or more media of claim 1, wherein a portion of the route is within a building, and
displaying the destination of the route comprises:
displaying a representation of the building;
displaying a representation of one or more checkpoints within the representation of the building.

12. The one or more media of claim 11,
wherein the operations further comprise displaying a geographic location of a checkpoint with reference to other geographic locations in the building, and contact information of an individual associated with the checkpoint.

13. One or more non-transitory machine-readable media storing instructions which, when executed by one or more processors, cause:
displaying a representation of a route for transporting an item from a source location to a destination location;
wherein a plurality of tasks is to be carried out at a plurality of locations along the route by a plurality of transport providers;
responsive to receiving a first user selection of a first location, of the plurality of locations, along the route: displaying information identifying a first transport provider, of the plurality of transport providers, that is responsible for carrying out a first task associated with the first location;
responsive to receiving a second user selection of a second location, of the plurality of locations, along the route: displaying information identifying a second transport provider, of the plurality of transport providers, that is responsible for carrying out a second task, of the plurality of tasks, associated with the second location; and
wherein the first transport provider and the second transport provider are different.

14. The one or more media of claim 13, wherein the operations further comprise:
detecting user input that drags a time marker on a timeline;
responsive to and concurrently with detecting the user input:
moving a position marker along the representation of the route;
displaying information corresponding to a segment on the representation of the route currently associated with the position marker.

15. A method, comprising:
training a machine learning model to compute route attributes for at least one transport provider for transporting items along a route between a source location and a destination location, the training comprising:
obtaining training data sets of historical transport data, each training data set comprising one or more of:
attributes of a particular transport provider for a prior transport of a particular item along a particular route;
a time taken by the particular provider for the prior transport of the particular item along the particular route; and
a cost for the prior transport of the particular item along the particular route; and
training the machine learning model based on the training data sets;
receiving a request to display the route for transporting a target item from the source location to the destination location;
applying the machine learning model to predict an estimated time and an estimated cost for transporting the target item from the source location to the destination location; and
displaying a representation of the route, the representation comprising the estimated time and the estimated cost predicted by the machine learning model.

16. The method of claim 15, wherein:
responsive to receiving a first user selection of a first location, of the plurality of locations, along the route: displaying information identifying a first transport provider, of the plurality of transport providers, that is responsible for carrying out a first task associated with the first location;
responsive to receiving a second user selection of a second location, of the plurality of locations, along the route: displaying information identifying a second transport provider, of the plurality of transport providers, that is responsible for carrying out a second task, of the plurality of tasks, associated with the second location;
wherein the first transport provider and the second transport provider are different.

17. The method of claim 15, wherein:
responsive to receiving a first user selection of a first segment of the route: displaying one or more of: an estimated cost corresponding to the first segment of the route, or an estimated time corresponding to the first segment of the route.

18. The method of claim 15, wherein the operations further comprise:
detecting user input that drags a time marker on a timeline;
responsive to and concurrently with detecting the user input:
moving a position marker along a representation of the route;
displaying information corresponding to a segment on the route currently associated with the position marker.

19. The method of claim 15, wherein the operations further comprise: receiving user input selecting a position along the representation of the route corresponding to a change from a first transport provider to a second transport provider, and displaying information identifying the second transport provider.

20. The method of claim 15, wherein:
responsive to receiving a selection of a second route for transporting the target item from the source location to the destination location:
displaying a second representation of the second route, the second representation comprising a second estimated time and a second estimated cost predicted by the machine learning model.

21. The method of claim 15, further comprising:
determining that the first location corresponds to a transfer point for transfer of the item between different transport providers;
displaying information associated with the transfer, the information associated with the transfer comprising one or more attributes of the first transport provider that is responsible for delivering the item at the transfer point.

22. The method of claim 21, further comprising:
displaying a photograph of the item as received at the first transport point.

23. The method of claim 15, wherein the data sets further comprise one or more of:
different routes traveled by the transport provider between the source location and the destination location;
time taken by a vendor associated with the source location to ship the item; and
costs attributed to the vendor to ship the item.

24. The method of claim 15, wherein a portion of the route is within a building, and
displaying the destination of the route comprises:
displaying a representation of the building;
displaying a representation of one or more checkpoints within the representation of the building.

25. The method of claim 24,
wherein the operations further comprise displaying a geographic location of a checkpoint, among the one or more checkpoints, with reference to other geographic locations in the building, and contact information of an individual associated with the checkpoint.

26. The method of claim 15, wherein:
responsive to receiving a first user selection of a first location, of the plurality of locations, along the route:
displaying information identifying a first transport provider, of the plurality of transport providers, that is responsible for carrying out a first task associated with the first location;
responsive to receiving a second user selection of a second location, of the plurality of locations, along the route:
displaying information identifying a second transport provider, of the plurality of transport providers, that is responsible for carrying out a second task, of the plurality of tasks, associated with the second location;
wherein the first transport provider and the second transport provider are different,
wherein, responsive to receiving a third user selection of a first segment of the route:
displaying one or more of:
an estimated cost corresponding to the first segment of the route, or an estimated time corresponding to the first segment of the route
wherein the method further comprises:
detecting a first user input that drags a time marker on a timeline;
responsive to and concurrently with detecting the first user input:
moving a position marker along a representation of the route; and
displaying information corresponding to a second segment on the route currently associated with the position marker,
wherein the operations further comprise:
receiving a second user input selecting a position along the representation of the route corresponding to a change from the first transport provider to the second transport provider, and displaying information identifying the second transport provider,
wherein, responsive to receiving a fourth user selection of a second route for transporting the target item from the source location to the destination location:
displaying a second representation of the second route, the second representation comprising a second estimated time and a second estimated cost predicted by the machine learning model,
wherein the method further comprises:
determining that the first location corresponds to a transfer point for transfer of the item between different transport providers;
displaying information associated with the transfer, the information associated with the transfer comprising one or more attributes of the first transport provider that is responsible for delivering the item at the transfer point,
wherein the method further comprises:
displaying a photograph of the item as received at the first transport point, wherein the data sets further comprise one or more of:
different routes traveled by the transport provider between the source location and the destination location;
time taken by a vendor associated with the source location to ship the item; and
costs attributed to the vendor to ship the item,
wherein a portion of the route is within a building, and displaying the destination of the route comprises:
displaying a representation of the building; and
displaying a representation of one or more checkpoints within the representation of the building, and
wherein the operations further comprise displaying a geographic location of a checkpoint, among the one or more checkpoints, with reference to other geographic locations in the building, and contact information of an individual associated with the checkpoint.
